(19) United States
(12) Patent Application Publication
(10) Pub. No.: US 2023/0351291 A1
(43) Pub. Date: Nov. 2, 2023

(54) SYSTEMS AND METHODS FOR MANAGING WORKFLOWS

(71) Applicant: Kingfield Corporation, Naples, FL (US)

(72) Inventors: Jamie Bernardin, Kent, CT (US); Chris C. Tsai, Totowa, NJ (US); John Rodefeld, Port Jefferson, NY (US)

(73) Assignee: KingField Corporation, (omitted)

(21) Appl. No.: 18/130,097

(22) Filed: Apr. 3, 2023

Related U.S. Application Data
(60) Provisional application No. 63/327,106, filed on Apr. 4, 2022.

(51) Int. Cl. G06Q 10/0633; G06F 16/23

(52) U.S. Cl. CPC G06Q 10/0633; G06F 16/23

(57) ABSTRACT

Systems and methods for managing workflows are provided. In some embodiments, a workflow may be between a first organization and one or more second organizations. A first data record and one or more second data records may be stored for a ticket for the workflow. The first data record may be associated with the first organization. The one or more second data records may be associated with the one or more second organizations, respectively. In response to an action taken by the first organization, both the first data record and the one or more second data records may be updated to reflect the action.

### RELATED APPLICATIONS

This application claims priority under 35 U.S.C. § 119(e) to U.S. Provisional Pat. Application No. 63/327,106 entitled, “SYSTEMS AND METHODS FOR MANAGING WORKFLOWS,” the entire content of which is incorporated by reference herein.

### BACKGROUND

Significant progress in digital transformation has been made over the past few decades. Nevertheless, information silos continue to exist in important industries such as manufacturing, logistics, healthcare, finance, etc. For instance, despite being in the same ecosystem, many organizations still have information management systems that are unable to communicate with each other, and therefore have to resort to inefficient methods (e.g., email, or even facsimile) for managing inter-organization workflows.

### SUMMARY

In accordance with some embodiments, a computer-implemented method is provided for managing workflows. A workflow may be between a first organization and one or more second organizations. The method may comprise acts of: storing a first data record and one or more second data records associated with a ticket for the workflow, wherein: the first data record is associated with the first organization; and the one or more second data records are associated with the one or more second organizations, respectively; and in response to an action taken by the first organization, updating both the first data record and the one or more second data records to reflect the action.

In one aspect, the first data record is stored in a first workflow data instance associated with the first organization, the one or more second data records are stored in one or more second workflow data instances associated with the one or more second organizations, respectively, and the first workflow data instance is segregated from the one or more second workflow data instances. In another aspect, the first data record and the one or more second data records are updated atomically. In another aspect, the first workflow data instance is associated with a first tenant in a multi-tenant database, the one or more second workflow data instances are associated with one or more second tenants in the multi-tenant database, respectively, and the first data record and the one or more second data records are updated via a single database transaction.

In another aspect, the first data record comprises a first payload field, the one or more second data records comprise a second payload field, and updating both the first data record and the one or more second data records comprises updating the first data record based on the action taken by the first organization, and copying content of the first payload field into the second payload field. In another aspect, the content of the first payload field comprises a structured data object. In another aspect, the structured data object in the first payload field stores ticket information shared between the first organization and the one or more second organizations, and the first data record further comprises at least one other field storing ticket information specific to the first organization. In another aspect, the structured data object in the first payload field stores ticket information common across a plurality of workflow types, the workflow is associated with a first workflow type of the plurality of workflow types, and the first data record further comprises at least one other field storing ticket information specific to the first workflow type.

In another aspect, the first data record comprises a first payload field, the one or more second data records comprise a second payload field, and updating both the first data record and the one or more second data records comprises applying one or more data transformation rules to at least a portion of content of the first payload field, thereby obtaining a data transformation result, and updating the second payload field based on the data transformation result. In another aspect, prior to the action taken by the first organization, the first data record is in a first state, and the one or more second data records are in one or more second states, respectively. The one or more second states match the first state, updating both the first data record and the second data record comprises updating the first data record to be in a third state, and updating the one or more second data records to be in one or more fourth states, respectively, and the one or more fourth states match the third state. In another aspect, prior to the action taken by the first organization the first data record is in a first state, and the one or more second data records are in one or more second states, respectively; the one or more second states match the first state. Updating both the first data record and the second data record comprises updating the first data record to be in a third state, and after the action taken by the first organization, the one or more second data records remain in the one or more second states, respectively, and the one or more second states match the third state.

In accordance with some embodiments, a system is provided, comprising at least one processor and at least one computer-readable storage medium having stored thereon instructions which, when executed, program the at least one processor to perform any of the methods described herein.

In accordance with some embodiments, at least one computer-readable storage medium is provided, having stored thereon instructions which, when executed, program at least one processor to perform any of the methods described herein.

### BRIEF DESCRIPTION OF DRAWINGS

FIG. 1 shows an illustrative workflow management system 100, in accordance with some embodiments.

FIG. 2A shows an illustrative dashboard 200, in accordance with some embodiments.

FIG. 2B shows illustrative states 225 in the example of FIG. 2A, as well as illustrative states 230, in accordance with some embodiments.

FIGS. 3A-B show illustrative outgoing ticket states 300-S and illustrative incoming ticket states 300-R, in accordance with some embodiments.

FIGS. 4A-B show illustrative outgoing ticket record 400-S and illustrative incoming ticket record 400-R, in accordance with some embodiments.

FIG. 5 shows an illustrative ticket table 500, in accordance with some embodiments.

FIG. 6 shows an illustrative ticket 600, in accordance with some embodiments.

FIG. 7 shows illustrative input data 700 in an unstructured form, in accordance with some embodiments.

FIGS. 8A-C show illustrative textual data 800 obtained from the illustrative input data 700 in the example of FIG. 7, in accordance with some embodiments.

FIG. 9 shows an illustrative process 900 for transforming unstructured data into structured data, in accordance with some embodiments.

FIG. 10 shows an illustrative data schema 1050, in accordance with some embodiments.

FIG. 11 shows illustrative output data 1100 in a structured form, in accordance with some embodiments.

FIG. 12 shows, schematically, an illustrative computer 1000 on which any aspect of the present disclosure may be implemented.

### DETAILED DESCRIPTION

Aspects of the present disclosure relate to systems and methods for managing workflows, such as workflows between organizations with information management systems that are unable to communicate with each other.

The inventors have recognized and appreciated various challenges associated with inter-organizational workflows. For instance, different organizations may use different data schemas to manage the same set of data elements involved in a workflow. As a result, it may be challenging to ingest data received from a sender organization into a workflow management system of a recipient organization. Indeed, data is often transmitted in an unstructured form (e.g., an email and/or a PDF attachment with textual information that is not annotated with metadata), and is manually entered into a recipient organization’s workflow management system. Such manual data entry may be labor intensive and error prone.

Moreover, task tracking may be challenging with workflow management systems that are not coupled to each other. As an example, a US company may be part of a transaction in a foreign jurisdiction, where the transaction may be subject to value-added tax (VAT) withholding by a foreign tax authority. There may be a limited window of time within which a refund may be requested. A US custodian representing the US company may not be authorized to submit a refund request directly to the foreign tax authority, and may therefore engage a local custodian to do so. As a result, the US custodian may have limited visibility into the status of the request (e.g., when the request is submitted, whether the foreign tax authority requires additional information, etc.). This may lead to a higher likelihood of missing the refund request deadline, which may in turn result in significant losses for the US company.

While it may be possible to provide a workflow management system that is accessible remotely by multiple organizations, the inventors have recognized and appreciated that some organizations, especially those in highly regulated industries such as healthcare and finance, may be reluctant to adopt such a solution. For instance, a workflow management system may store information relating to a ticket in a database record that is accessible by all organizations involved in that ticket. Such shared access may raise data governance issues (e.g., data integrity, confidentiality, privacy, etc.).

Accordingly, in some embodiments, a workflow management system may be provided that maintains multiple data records for an individual ticket. For instance, there may be a separate record for each organization involved in the ticket. Such a record may store information that is specific to the particular organization, and/or information that is common across all of the organizations involved in the ticket. In this manner, each organization may have its own set of data records (corresponding, respectively, to all tickets in which the organization is involved), and may enforce its own data governance rules over that set of data records.

The inventors have recognized and appreciated that replicating data at multiple records may create data consistency challenges. For example, a data discrepancy may arise if a data element is updated in a record maintained for a sender organization after a version of the data element has been shared with a recipient organization, but the update is not propagated to a record maintained for the recipient organization.

Accordingly, in some embodiments, techniques are provided for designing workflows to enforce data consistency. For instance, each data record may be associated with one of a plurality of states, where performance of a task in a workflow may cause the data record to transition from one state to another state. Given two or more data records associated with the same ticket, states of the data records may be matched, so that an update in one data record may entail a corresponding update in the other data record(s).

The inventors have further recognized and appreciated that adoption of a workflow management system may happen gradually across an ecosystem. For instance, it may be challenging to integrate a workflow management system with a back office system consisting of a patchwork of components that have been added and stitched together over decades. This may prevent some organizations from quickly adopting the workflow management system.

Therefore, an organization that has adopted a workflow management system may, initially, still have to interact with an organization that has not adopted the same system. Accordingly, in some embodiments, techniques are provided for data transformation at a boundary of a workflow management system. For instance, unstructured data received from a sender organization outside the workflow management system may be transformed into structured data according to a selected data schema. The resulting structured data may then be ingested by the workflow management system, and may be stored in a data record associated with a recipient organization within the workflow management system.

It should be appreciated that the techniques introduced above and/or described in greater detail below may be implemented in any of numerous ways, as these techniques are not limited to any particular manner of implementation. Examples of implementation details are provided herein solely for purposes of illustration. Furthermore, the techniques described herein may be used individually or in any suitable combination, as aspects of the present disclosure are not limited to any particular technique or combination of techniques.

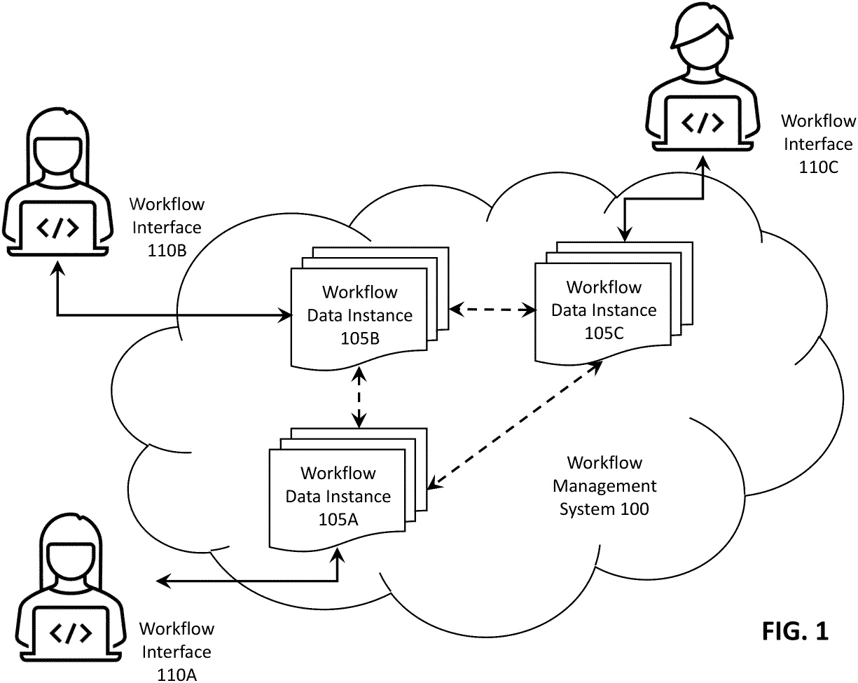

FIG. 1 shows an illustrative workflow management system 100, in accordance with some embodiments. In this example, the workflow management system 100 includes workflow data instances 105A-C with corresponding workflow interfaces 110A-C.

In some embodiments, the workflow data instances 105A-C may be associated with, respectively, three different organizations. For instance, the workflow data instance 105A may be associated with a US claimant in a foreign VAT refund workflow, whereas the workflow data instances 105B-C may be associated with, respectively, a US custodian and a foreign custodian in the same workflow.

The workflow data instances 105A-C may be implemented in any suitable manner. In some embodiments, the workflow data instances 105A-C may share a common set of data schemas, but may be logically and/or physically segregated. For example, the workflow data instances 105A-C may reside in a multi-tenant database, where each of the workflow data instances 105A-C is associated with a respective tenant identifier.

In some embodiments, a workflow interface (e.g., any of the workflow interfaces 110A-C) may be configured to allow a user to create a ticket to be dispatched through the workflow management system 100. Additionally, or alternatively, the workflow interface may be configured to display, to the user, one or more tickets stored in the corresponding workflow data instance.

A workflow interface may be implemented in any suitable manner. As an example, a workflow interface may include a web browser configured to execute one or more scripts (e.g., in JavaScript) received from the workflow management system 100. As another example, a workflow interface may include stand-alone software installed on a client device (e.g., a desktop computer, or a mobile device such as a laptop computer, a tablet computer, a smartphone, etc.). The stand-alone software may be configured to communicate with the workflow management system 100 via one or more remote application programming interfaces (APIs).

In some embodiments, a workflow interface may communicate with the workflow management system 100 via one or more network interfaces. Such a network interface may use any suitable networking technology, such as 5G, LTE, WiMAX, WiFi, Ethernet, Bluetooth, etc.

While details of implementation are described above in connection with FIG. 1, it should be appreciated that such details are provided solely for purposes of illustration. For instance, the workflow management system 100 may have a multi-instance architecture, instead of a multi-tenant architecture. Moreover, aspects of the present disclosure are not limited to implementing all workflow interfaces in a common manner. In some embodiments, the workflow interface 110A may be provided via a web browser, whereas the workflow interface 110B may be provided as a stand-alone application running on a client device, or vice versa.

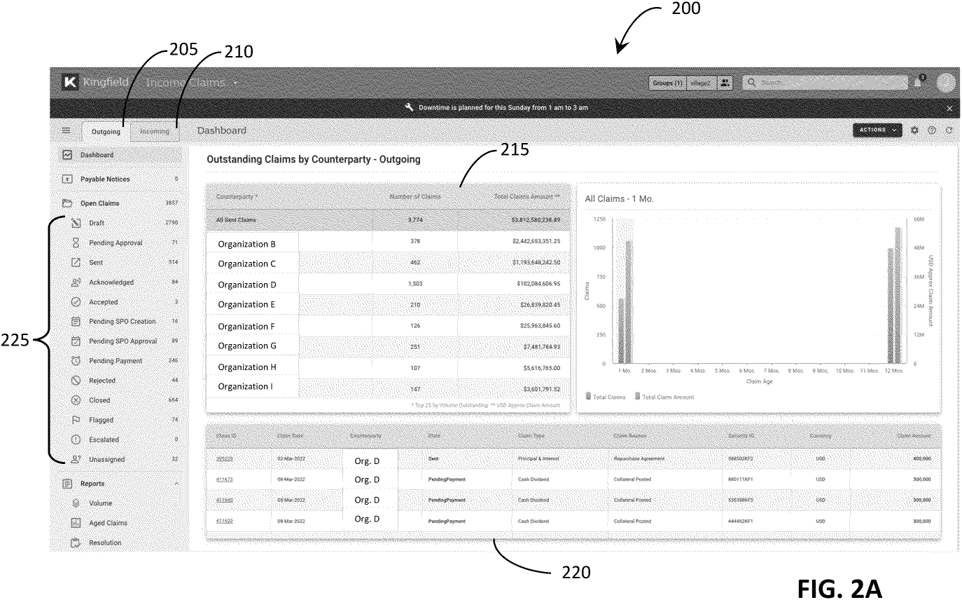

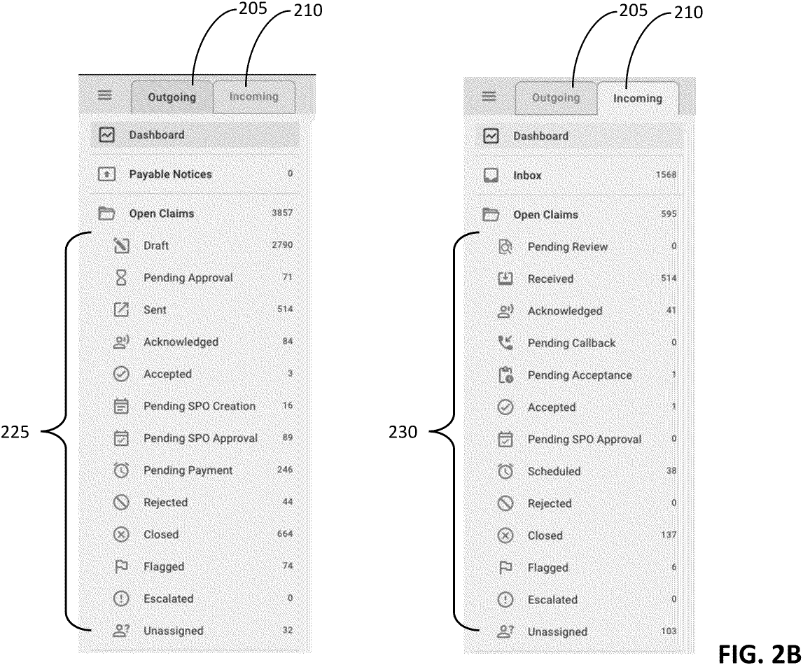

FIG. 2A shows an illustrative dashboard 200, in accordance with some embodiments. For instance, the dashboard 200 may be displayed to a user by one of the illustrative workflow interfaces 110A-C in the example of FIG. 1.

In the example of FIG. 2A, the dashboard 200 is used by an organization (hereafter referred to as Organization A) to manage workflows related to income claims. For instance, clients may have established accounts with Organization A to hold shares of different companies. When a company declares a dividend payment, Organization A may send one or more claims to an organization responsible for dispersing the dividend payment (e.g., one of Organizations B-I). Conversely, Organization A may be responsible for dispersing a dividend payment for a company, and may receive claims from other organizations (e.g., Organizations B-I).

In some embodiments, the dashboard 200 may include an outgoing tab 205 and an incoming tab 210. The outgoing tab 205 may show tickets relating to claims sent by Organization A to other organizations, where the incoming tab 210 may show tickets relating to claims received by Organization A from other organizations.

In the example of FIG. 2A, the outgoing tab 205 is shown, while the incoming tab 210 is hidden. The outgoing tab 205 may include a summary table 215 indexed by counterparty (e.g., Organizations B-I). For each counterparty, the summary table 215 may show a number of tickets received from that counterparty, as well as an aggregate amount of such tickets.

Additionally, or alternatively, the outgoing tab 205 may include a ticket table 220 indexed by ticket identifier. For each ticket, the outgoing tab 205 may show a plurality of data elements of that ticket, such as ticket date, counterparty, state, ticket type, ticket reason, security identifier, currency, ticket amount, etc.

In some embodiments, the outgoing tab 205 may allow the user to filter tickets based on state. For instance, at any given point in time, an outgoing ticket may be in one of a plurality of states 225. By clicking on one of the states 225, the user may view all outgoing tickets that are currently in that state.

FIG. 2B shows the illustrative states 225 in the example of FIG. 2A, as well as illustrative states 230, in accordance with some embodiments. For instance, at any given point in time, an incoming ticket may be in one of the states 230. The user may navigate to the states 230 by clicking the incoming tab 210, and may view all incoming tickets in a selected state by clicking on that state.

Although workflows for income claims are shown in FIGS. 2A-B and described above, it should be appreciated that aspects of the present disclosure are not limited to such workflows. One or more of the techniques described herein may be used to manage other types of workflows, such as workflows for healthcare reimbursement, supply chain management, etc.

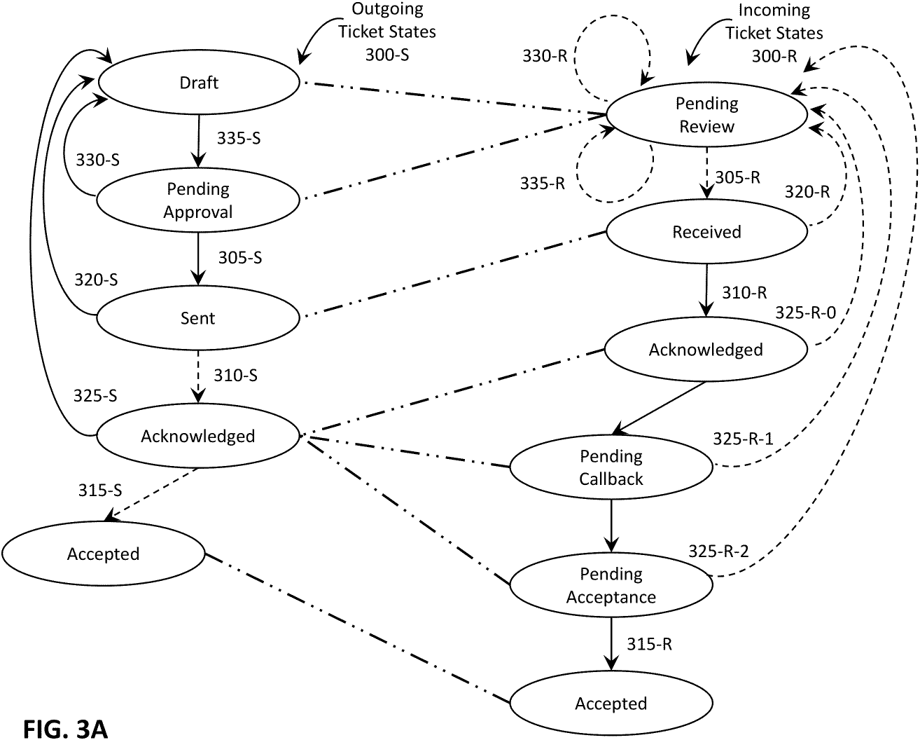

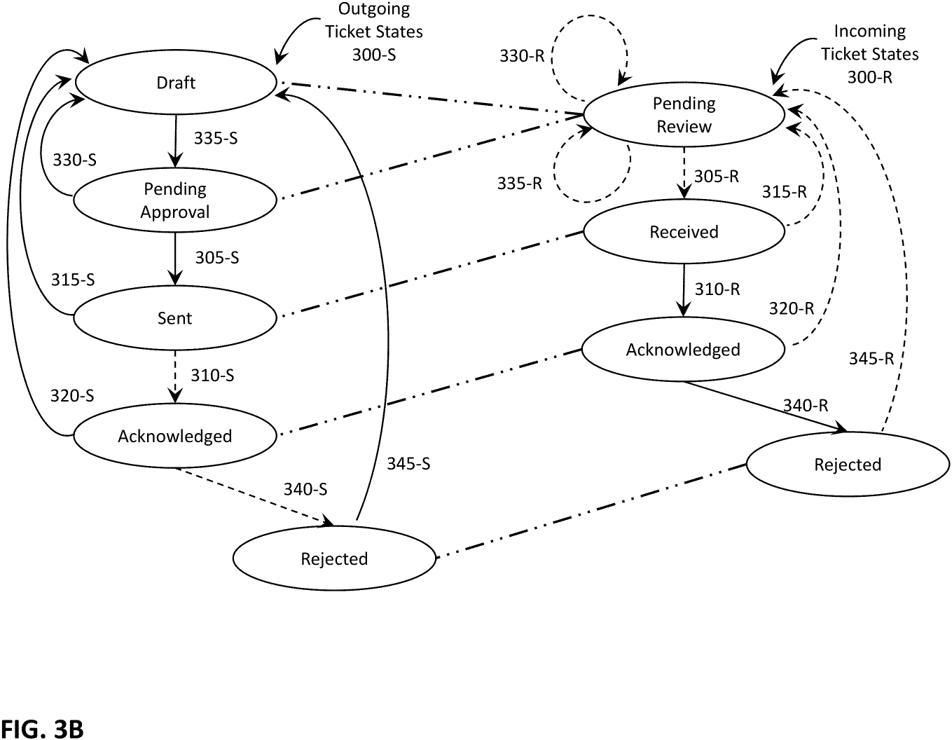

FIGS. 3A-B show illustrative outgoing ticket states 300-S and illustrative incoming ticket states 300-R, in accordance with some embodiments. The outgoing ticket states 300-S may be similar to the illustrative states 225 in the example of FIGS. 2A-B. Likewise, the incoming ticket states 300-R may be similar to the illustrative states 230 in the example of FIGS. 2A-B.

In some embodiments, a user at a sender organization (e.g., Organization A) may create a ticket via a workflow interface (e.g., the illustrative workflow interface 105A in the example of FIG. 1). In response, a workflow management system (e.g., the illustrative workflow management system 100) may initialize a data record in a workflow data instance associated with Organization A (e.g., the illustrative workflow data instance 105A). The data record may be assigned a Draft state, and may store ticket information that is common to Organization A and an intended recipient organization (e.g., Organization B). Examples of such ticket information include, but are not limited to, ticket identifier, ticket creation date, ticket type, ticket reason, security identifier, currency, ticket amount, etc.

Additionally, or alternatively, the data record may store ticket information that is specific to Organization A, such as counterparty (in this case, Organization B), assignee (e.g., the user who creates the ticket, or another responsible user at Organization A), state, last modification date, etc.

In some embodiments, the user who creates the ticket may send the ticket to another user (e.g., a manager or other supervisory user) at Organization A for internal review. Accordingly, the workflow management system 100 may update the ticket to a Pending Approval state. Once the supervisory user approves, the workflow management system 100 may dispatch the ticket to the Organization B.

In the example of FIG. 3A, dispatching of the ticket may be shown as a transition 305-S from the Pending Approval State to a Sent state. The transition 305-S may cause the workflow management system 100 to initialize a data record in a workflow data instance associated with Organization B (e.g., the illustrative workflow data instance 105B). The data record at Organization B may be assigned a Received state, and may store ticket information that is common to both Organizations A and B. Such ticket information may be copied from the corresponding data record at Organization A.

Additionally, or alternatively, the data record at Organization B may store ticket information that is specific to Organization B, such as counterparty (in this case, Organization A), assignee (e.g., a responsible user at Organization B), state, last modification date, etc.

In some embodiments, the workflow management system 100 may manage the data record at Organization A and the corresponding data record at Organization B in a coordinated manner, so that these data records may progress together through a series of matched states, thereby enforcing data consistency.

For instance, the Sent state on the sender side may be matched to the Received state on the recipient side. A user at Organization B may be notified of the incoming ticket, and may update the data record at Organization B from the Receive state to an Acknowledged state. This is shown in the example of FIG. 3A as a transition 310-R. The transition 310-R may cause the workflow management system 100 to update the corresponding data record at Organization A, for example, from the Sent state to an Acknowledged state. This is shown in the example of FIG. 3A as a matched transition 310-S, and the Acknowledged state on the sender side may be matched to the Acknowledged state on the recipient side.

In some embodiments, when matched transitions take place, at most one of the transitions may be active, while the remaining transition(s) may be passive. For instance, the transition 310-R may be active (shown as a solid arrow in FIG. 3A), while the transition 310-S may be passive (shown as a dashed arrow in FIG. 3A).

Accordingly, the workflow management system 100 may copy information from the data record of the active transition to the data record(s) of the passive transition(s). As an example, with respect to the matched transitions 310-R and 310-S, information may be copied from the data record of the active transition 310-R (at Organization B) to the data record of the passive transition 310-S (at Organization A). In some embodiments, information common to both Organization A and Organization B may be copied, whereas information specific to Organization B may not be copied.

It should be appreciated that aspects of the present disclosure are not limited to copying information from a data record of an active transition to a data record of a passive transition. In some embodiments, an active transition may have one or more associated rules for data transformation (e.g., selective obfuscation to comply with privacy regulations). Additionally, or alternatively, a passive transition may have one or more associated rules for data transformation (e.g., format conversion). Accordingly, when an active transition triggers a passive transition, the workflow management system 100 may apply one or more data transformation rules of the active transition and/or the passive transition to information from a data record of the active transition. A result of the data transformation may be used to update a data record of the passive transition.

The inventors have recognized and appreciated that consistency across the data records may be provided by ensuring that there is at most one active transition among the matched transitions. Indeed, after completion of the matched transitions, all data record(s) of the passive transition(s) may be consistent with the data record of the active transition, and therefore may also be consistent with each other.

In some embodiments, Organization B may perform one or more internal tasks to process the incoming ticket. For instance, the data record at Organization B may progress from the Acknowledged state to a Pending Callback state, and then to a Pending Acceptance state. These transitions may only affect information that is specific to the Organization B. Information that is common to Organizations A and B may not be affected. Therefore, there may be no matched transition on the sender side, and the Pending Callback state and the Pending Acceptance state on the recipient side may be matched to the Acknowledged state on the sender side.

When Organization B determines that the incoming ticket is to be accepted, the data record at Organization B may progress from the Pending Acceptance state to an Accepted state. This is shown in the example of FIG. 3A as a transition 315-R. The transition 315-R may cause the workflow management system 100 to update the corresponding data record at Organization A, for example, from the Acknowledged state to an Accepted state. This is shown in the example of FIG. 3A as a matched transition 315-S, and the Accepted state on the sender side may be matched to the Accepted state on the recipient side.

In this example, the transition 315-R is active (shown as a solid arrow in FIG. 3A), while the transition 315-S may be passive (shown as a dashed arrow in FIG. 3A). Accordingly, the workflow management system 100 may update the corresponding data record at Organization A, for example, by copying information from the data record at Organization B to the data record at Organization A.

In some embodiments, Organization A may modify the outgoing ticket prior to acceptance. For instance, Organization A may do so after the ticket has been sent to Organization B, but before Organization B has acknowledged, thereby returning the data record at Organization A from the Sent state to the Draft state. This is shown in the example of FIG. 3A as a transition 320-S. The transition 320-S may cause the workflow management system 100 to update the corresponding data record at Organization B, for example, from the Received state to a Pending Review state. This is shown in the example of FIG. 3A as a matched transition 320-R, and the Draft state on the sender side may be matched to the Pending Review state on the recipient side.

In this example, the transition 320-S is active (shown as a solid arrow in FIG. 3A), while the transition 320-R may be passive (shown as a dashed arrow in FIG. 3A). Accordingly, the workflow management system 100 may update the corresponding data record at Organization B, for example, by copying information from the data record at Organization A to the data record at Organization B.

Additionally, or alternatively, Organization A may modify the outgoing ticket after the ticket has been acknowledged by Organization B. This is shown in the example of FIG. 3A as a transition 325-S, which may be matched to a transition 325-R-0, 325-R-1, or 325-R-2, depending on whether the data record at Organization B is in the Acknowledged, Pending Callback, or Pending Acceptance state. The transitions 325-S and 325-R-i (i = 0, 1, 2) may be similar to the transitions 320-S and 320-R, as described above.

Additionally, or alternatively, Organization A may modify the outgoing ticket while the ticket is pending supervisory review. Accordingly, the workflow management system 100 may return the data record at Organization A from the Pending Review state to the Draft state. This is shown in the example of FIG. 3A as a transition 330-S.

In some embodiments, if the transition 330-S happens before the ticket has been sent to Organization B and thus before the data record at Organization B has been created, there may be no matched transition on the recipient side. If, on the other hand, the transition 330-S happens after the ticket has been sent to Organization B at least once, the transition 330-S may cause the workflow management system 100 to update the corresponding data record at Organization B. This is shown in the example of FIG. 3A as a matched transition 330-R, which may be a loop because the data record at Organization B may remain in the Pending Review state.

In this example, the transition 330-S is active (shown as a solid arrow in FIG. 3A), while the transition 330-R may be passive (shown as a dashed arrow in FIG. 3A). Accordingly, the workflow management system 100 may update the corresponding data record at Organization B, for example, by copying information from the data record at Organization A to the data record at Organization B.

In some embodiments, having been returned to the Draft state, the data record at Organization A may progress to the Pending Approval state, and then to the Sent state, as described above. The transition from the Draft state to the Pending Approval state is shown in the example of FIG. 3A as a transition 335-S, which may be matched to a transition 335-R on the recipient side. The transitions 335-S and 335-R may be similar to the transitions 330-S and 330-R, as described above.

Likewise, the transition 305-S from the Pending Approval state to the Sent state may be matched to a transition 305R on the recipient side. Accordingly, the workflow management system 100 may update the corresponding data record at Organization B, for example, by copying information from the data record at Organization A to the data record at Organization B.

In some embodiments, Organization B may determine that the incoming ticket is to be rejected. Accordingly, the data record at Organization B may progress from the Acknowledged state to a Rejected state. This is shown in the example of FIG. 3B as a transition 340-R. (For a less cluttered presentation, the Accepted, Pending Callback, and Pending Acceptance states, as well as associated transitions, are omitted from FIG. 3B.)

The transition 340-R may cause the workflow management system 100 to update the corresponding data record at Organization A, for example, from the Acknowledged state to a Rejected state. This is shown in the example of FIG. 3B as a matched transition 340-S, and the Rejected state on the sender side may be matched to the Rejected state on the recipient side.

In this example, the transition 340-R is active (shown as a solid arrow in FIG. 3A), while the transition 340-S may be passive (shown as a dashed arrow in FIG. 3A). Accordingly, the workflow management system 100 may update the corresponding data record at Organization A, for example, by copying information from the data record at Organization B to the data record at Organization A.

In response to Organization B rejecting the ticket, Organization A may modify the ticket (e.g., to address one or more issues raised by Organization B). This is shown in the example of FIG. 3B as a transition 345-S, which may be matched to a transition 345-R on the recipient side. The transitions 345-S and 345-R may be similar to the transitions 320-S and 320-R, as described above in connection with the example of FIG. 3A.

Although details of implementation are described above in connection with FIGS. 3A-B, it should be appreciated that such details are provided solely for purposes of illustration. For instance, aspects of the present disclosure are not limited to labeling a ticket with any particular state, or any state at all.

Moreover, aspects of the present disclosure are not limited to managing a workflow between two organizations. In some embodiments, three or more organizations may participate in a workflow. Thus, an active transition at one organization (e.g., the foreign custodian in the VAT example described above) may trigger multiple passive transitions at multiple counterparty organizations (e.g., the US claimant and the US custodian in the VAT example described above), respectively.

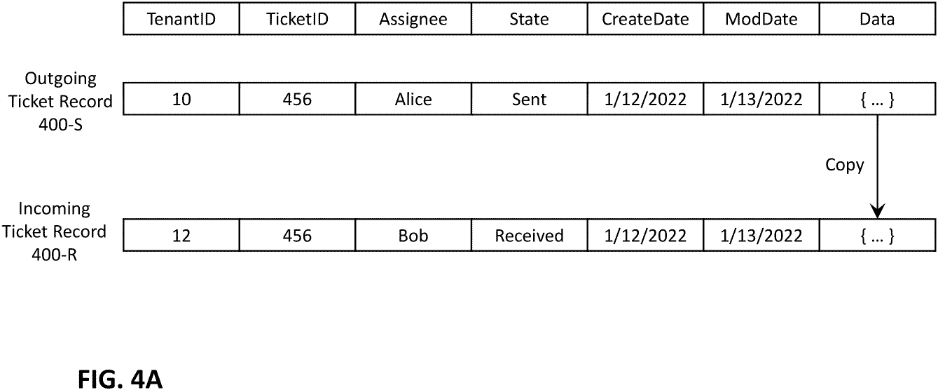

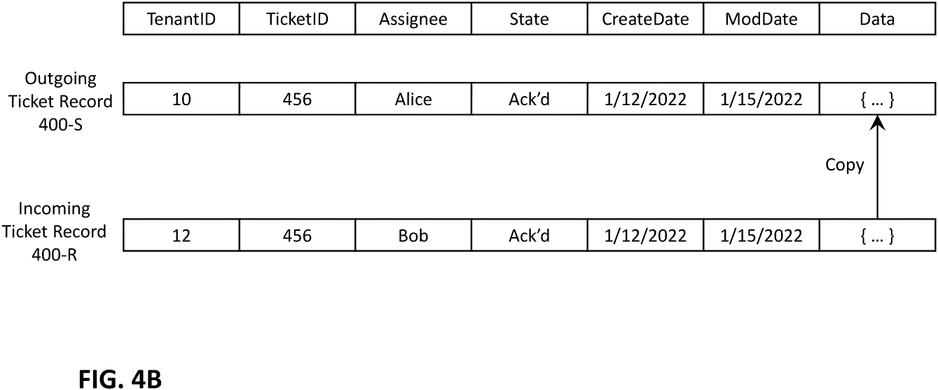

FIGS. 4A-B show illustrative outgoing ticket record 400-S and illustrative incoming ticket record 400-R, in accordance with some embodiments. For instance, the outgoing ticket record 400-S and the incoming ticket record 400-R may be, respectively, the data records at Organizations A and B in the example of FIGS. 3A-B.

In the example of FIG. 4A, ticket information that is common to both Organizations A and B is stored in a Data field of the outgoing ticket record 400-S. In response to a State field of the outgoing ticket record 400-S being updated to Sent (e.g., as described above in connection with the illustrative transition 305-S in the example of FIG. 3A), a workflow management system (e.g., the illustrative workflow management system 100 in the example of FIG. 1) may copy content of the Data field of the outgoing ticket record 400-S into a Data field of the incoming ticket record 400-R. Additionally, or alternatively, the workflow management system 100 may update a State field of the incoming ticket record 400-R to Received (e.g., as described above in connection with the illustrative transition 305-R in the example of FIG. 3A).

In some embodiments, the following operations may be performed atomically: (1) updating the State field of the outgoing ticket record 400-S to Sent, (2) copying the content of the Data field of the outgoing ticket record 400-S into the Data field of the incoming ticket record 400-R, and (3) updating the State field of the incoming ticket record 400-R to Received. In this manner, the transitions 305-S and 305-R may be effectuated simultaneously (e.g., via a single database transaction), and the state on the sender side may remain matched to the state on the recipient side.

In the example of FIG. 4B, in response to the State field of the incoming ticket record 400-R being updated to Acknowledged (e.g., as described above in connection with the illustrative transition 310-R in the example of FIG. 3A), the workflow management system 100 may copy content of the Data field of the incoming ticket record 400-R into the Data field of the outgoing ticket record 400-S. Additionally, or alternatively, the workflow management system 100 may update the State field of the outgoing ticket record 400-S to Acknowledged (e.g., as described above in connection with the illustrative transition 310-S in the example of FIG. 3A).

In some embodiments, the Data field of the outgoing ticket record 400-S (and likewise the Data field of the incoming ticket record 400-R) may be configured to store a structured data object, as opposed to just a single data value. For instance, the structured data object may be a JSON object.

The inventors have recognized and appreciated that, although different data schemas may be used for different types of workflows, such data schemas may share certain commonalities. Accordingly, in some embodiments, an underlying database schema may be provided with fields that are common across many, if not all, types of workflows of interest. The illustrative schema in the example of FIGS. 4A-B may include such fields (e.g., TenantID, TicketID, Assignee, State, CreateDate, ModDate, etc.).

By contrast, data elements that are specific to each type of workflow may be packaged into a structured data object, which may be stored in a payload field (e.g., Data) in the underlying database schema. In this manner, the same underlying database schema may be used for different types of workflows. This may reduce, or even eliminate, the need to perform a database reconfiguration whenever a new workflow type is encountered.

Moreover, if an existing workflow type is extended to include a new data element, such a data element may simply be added to a schema for the Data field, without having to perform a database reconfiguration.

While it may be desirable to have an underlying database schema that is universally applicable (or nearly so), it should be appreciated that aspects of the present disclosure are not so limited. In some embodiments, each organization may have its own database schema to store information specific to that organization, whereas information that is common across multiple organizations may be packaged into a structured data object to be stored in a selected field in the database schema. This arrangement may facilitate data synchronization, for example, as described above in connection with the illustrative copy operations in the example of FIGS. 4A-B.

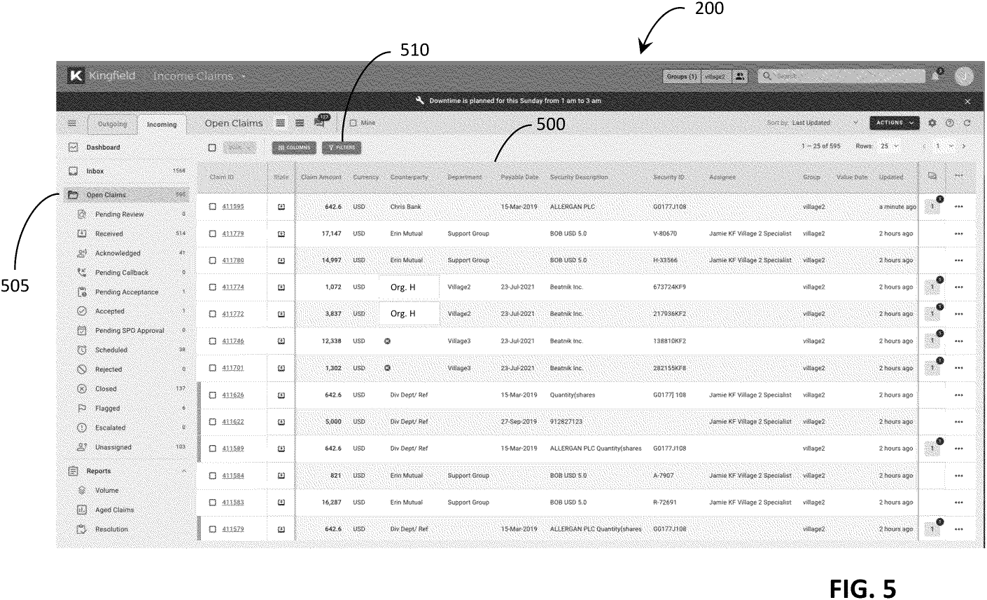

FIG. 5 shows an illustrative ticket table 500, in accordance with some embodiments. For instance, a user may bring up the ticket table 500 by clicking an Open Tickets button 505 from the illustrative dashboard 200 in the example of FIG. 2A.

In some embodiments, the dashboard 200 may allow the user to sort tickets by state (e.g., using a Filter button 510). For instance, in the example of FIG. 5, only those tickets in a Received state are shown.

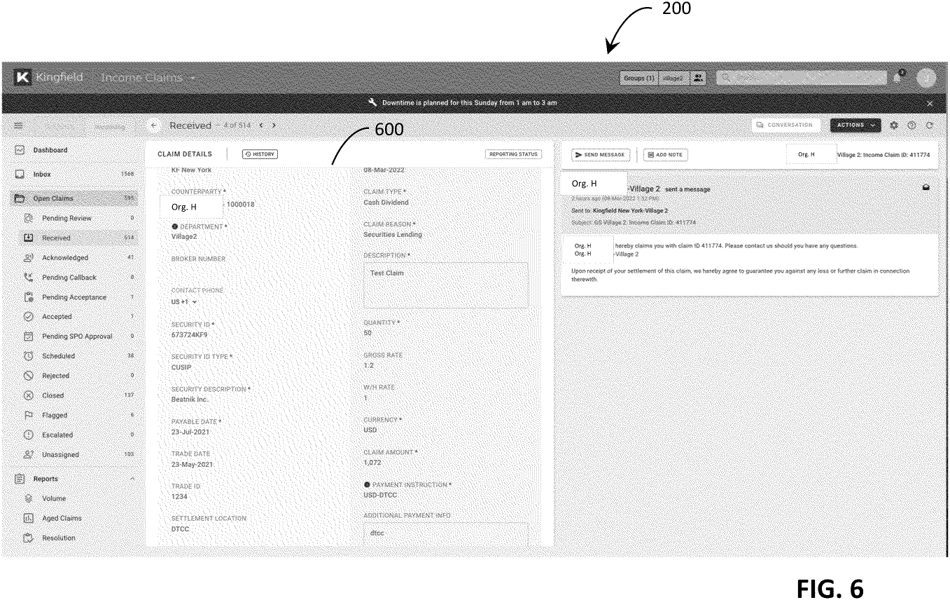

FIG. 6 shows an illustrative ticket 600, in accordance with some embodiments. For instance, the ticket 600 may be displayed to a user in response to the user selecting the ticket 600 from the illustrative ticket table 500 in the example of FIG. 5.

As discussed above, adoption of a workflow management system may happen gradually across an ecosystem. For instance, it may be challenging to integrate a workflow management system with a back office system consisting of a patchwork of components that have been added and stitched together over decades. This may prevent some organizations from quickly adopting the workflow management system. Therefore, an organization that has adopted the workflow management system may, initially, still have to interact with an organization that has not adopted the same system.

The inventors have recognized and appreciated various challenges associated with data transformation at a boundary of a workflow management system. For instance, when data is received in an unstructured form from a sender organization outside the workflow management system, it may be challenging to transform such data into a structured form according to a selected data schema, so that the received data may be ingested by the workflow management system for storage in a data record associated with a recipient organization within the workflow management system.

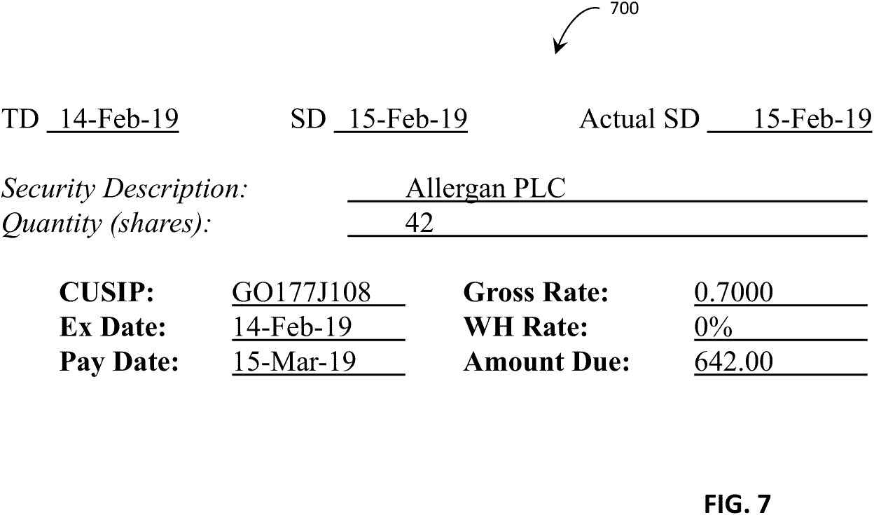

FIG. 7 shows illustrative input data 700 in an unstructured form, in accordance with some embodiments. For instance, the input data 700 may be received by Organization A from one of Organizations B-I in the example of FIGS. 2A-B.

In this example, Organization A has adopted the illustrative workflow management system 100 in the example of FIG. 1, but Organization H has not. Thus, Organization H may have sent the input data 700 to Organization A via an email, either as text in the body of the email, or as an attachment (e.g., a PDF file).

In some embodiments, the workflow management system 100 may process the input data 700 to obtain textual data. As an example, if the input data 700 is in a native PDF file, the workflow management system 100 may use a native PDF text extraction tool to process the input data 700. As another example, if the input data 700 is in a scanned PDF file, the workflow management system 100 may use an optical character recognition (OCR) tool to process the input data 700.

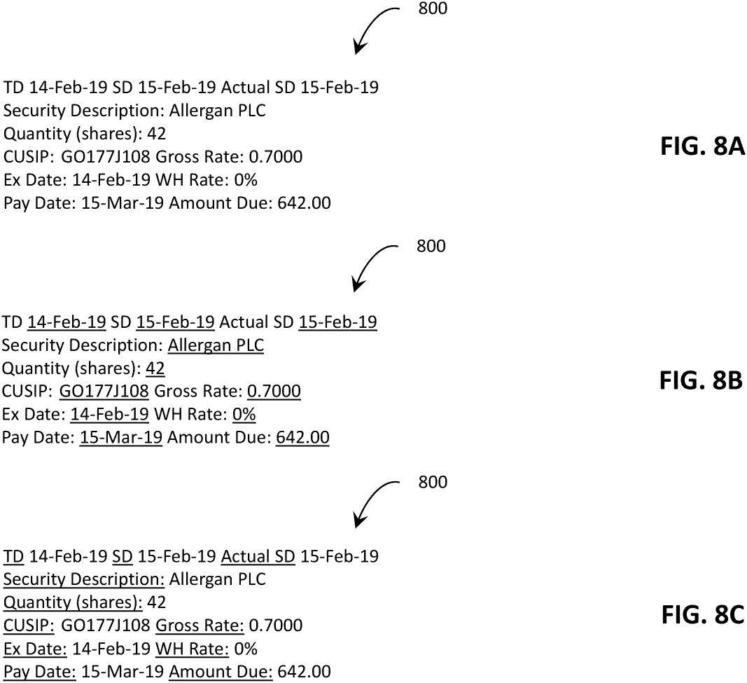

FIGS. 8A-C show illustrative textual data 800 obtained from the illustrative input data 700 in the example of FIG. 7, in accordance with some embodiments. The textual data 800 may be obtained in any suitable manner, for instance, directly from the body of an email, or using a native PDF text extraction tool or an OCR tool, as described above.

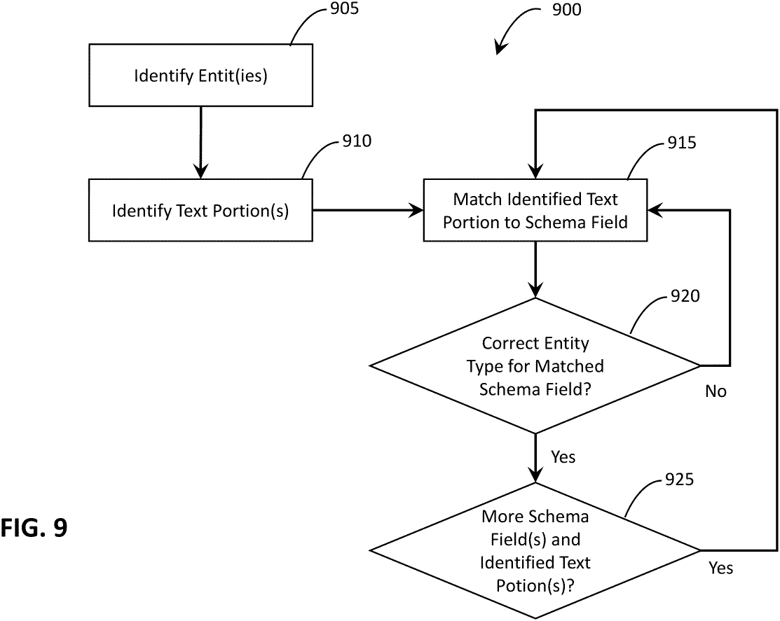

FIG. 9 shows an illustrative process 900 for transforming unstructured data into structured data, in accordance with some embodiments. For instance, the process 900 may be used by the illustrative workflow management system 100 in the example of FIG. 1 to transform the illustrative unstructured input data 700 in the example of FIG. 7 into a structured form.

At act 905, the workflow management system 100 may identify one or more entities (e.g., numbers, dates, proper names, etc.) from the input data 700. For instance, the workflow management system 100 may apply one or more natural language processing (NLP) techniques to process textual data obtained from the input data 700 (e.g., the illustrative textual data 800 in the example of FIG. 8A). This may result in the identification of one or more entities, examples of which are underlined in FIG. 8B.

At act 910, the workflow management system 100 may, for each entity identified at act 905, identify one or more text portions that are adjacent to the entity. For instance, the workflow management system 100 may identify a text portion to the right of the entity, a text portion to the left of the entity, a text portion above the entity (directly, or offset to the left or to the right), a text portion below the entity (directly, or offset to the left or to the right), etc. This may result in one or more text portions, examples of which are underlined in FIG. 8C.

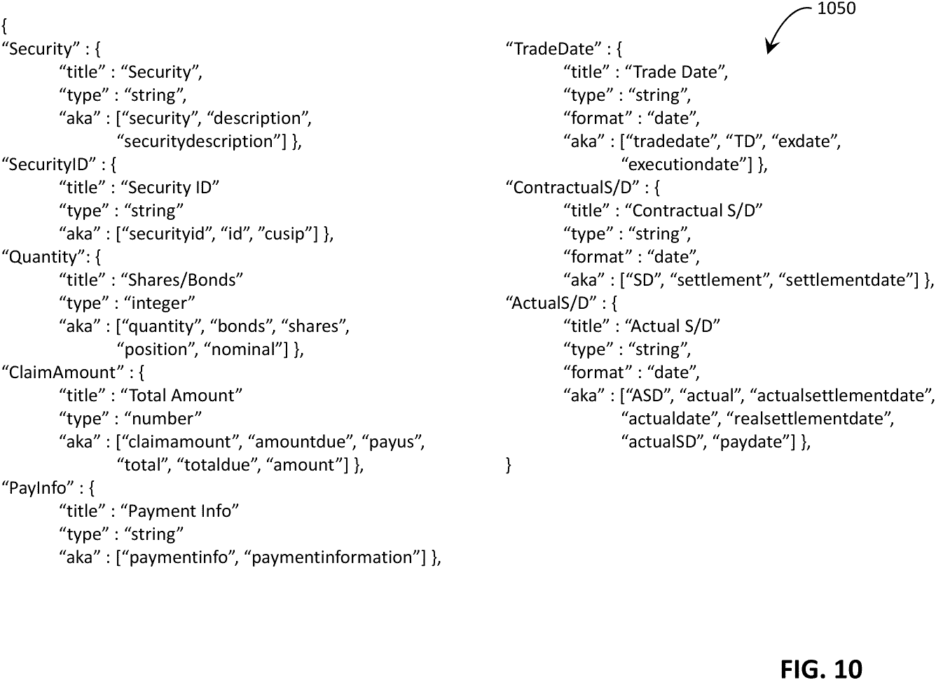

In some embodiments, the workflow management system 100 may attempt to populate a data object (e.g., as described in connection with the example of FIGS. 4A-B) based on one or more entities identified at act 905. Accordingly, the workflow management system 100 may attempt to match one or more fields in a data schema for the data object, respectively, to one or more entities identified at act 905. An example of such a data schema (namely, an illustrative data schema 1050) is shown in FIG. 10.

Referring again to the example of FIG. 9, at act 915, the workflow management system 100 may attempt to match text portions identified at act 910 to fields in the data schema 1050. For instance, the workflow management system 100 may start from the top line, go from left to right on each line, and then move to the next line below, and may process each identified text portion until all fields in the data schema 1050 have been populated, or all identified text portions have been processed. However, it should be appreciated that aspects of the present disclosure are not limited to processing identified text portions in any particular order.

In some embodiments, the fields in the data schema 1050 may be ordered by importance. Accordingly, for a given identified text portion, the workflow management system 100 may compare the identified text portion against each field in the order in which the fields appear in the data schema 1050. If a match is found, the workflow management system 100 may stop, and may not compare the identified text portion against any remaining field. However, it should be appreciated that aspects of the present disclosure are not limited to ordering the fields in the data schema 1050 in any particular manner, or to comparing the identified text portion against the fields in any particular order.

In some embodiments, for a given identified text portion and a given field in the data schema 1050, the workflow management system 100 may compare one or more synonyms in the field (e.g., in the “aka” attribute in the example of FIG. 10) against the identified text portion. A tentative match may be made if any synonym matches the identified text portion.

In some embodiments, to facilitate matching, the workflow management system 100 may pre-process the identified text portion. For instance, the workflow management system 100 may remove all spaces and/or punctuation marks. This may reduce false negative errors.

Additionally, or alternatively, a confidence score may be assigned to each tentative match. For instance, a confidence score may be assigned based on an extent to which a synonym matches an identified text portion (e.g., a Levenshtein distance between the synonym and the identified text portion). Accordingly, if there are multiple tentative matches, a match with a highest confidence score may be selected.

At act 920, the workflow management system 100 may check one or more entities associated with the identified text portion, such as an entity to the left of the identified text portion, an entity to the right of the identified text portion, an entity above the identified text portion (directly, or offset to the left or to the right), an entity below the identified text portion (directly, or offset to the left or to the right), etc. For instance, the workflow management system 100 may check if a type of each such entity matches a type of the field matched to the identified text portion at act 915 (e.g., in the “type” attribute in the example of FIG. 10).

In some embodiments, if no entity associated with the identified text portion has a type that matches the type of the matched field, the workflow management system 100 may return to act 915. For instance, the workflow management system 100 may compare the identified text portion against one or more remaining fields in the data schema 1050, in an attempt to find another matching field.

If, on the other hand, an entity associated with the identified text portion has a type that matches the type of the matched field, the workflow management system 100 may use that entity to populate the field.

At act 925, the workflow management system 100 may determine if the data schema 1050 has one or more fields that have not been populated, and if there are one or more identified text portions yet to be processed. If so, the workflow management system 100 may return to act 915 to process another identified text portion.

It should be appreciated that aspects of the present disclosure are not limited to matching identified text portions to schema fields in any particular manner, or at all. Additionally, or alternatively, schema fields may be matched to identified text portions.

Additionally, or alternatively, for a given identified text portion, a confidence score may be computed for each synonym in each field, and a synonym (and hence the associated field) with a highest confidence score may be selected. Accordingly, if it is determined at act 920 that no entity associated with the identified text portion has a type that matches the type of the matched field, the workflow management system 100 may return to act 915 to identify a next best match between a synonym and the identified text portion, and may repeat act 920 with the type of the associated field for that synonym.

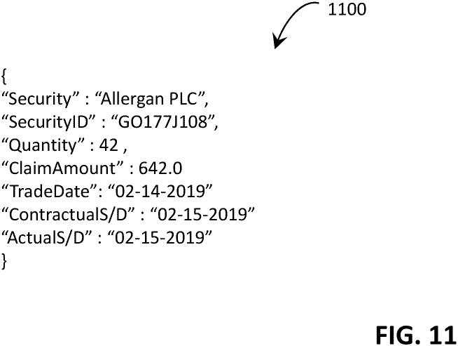

FIG. 11 shows illustrative output data 1100 in a structured form, in accordance with some embodiments. For instance, the output data 1100 may be a data object populated by the illustrative workflow management system 100 in the example of FIG. 1 via the illustrative process 900 in the example of FIG. 9.

In this example, the text portion “TD” matches the synonym “TD” in the “TradeDate” field. Accordingly, the entity to the right of the text portion “TD” (namely, “Feb. 14, 2019”) may be used to populate the “TradeDate” field.

Additionally, or alternatively, the text portion “SD” matches the synonym “SD” in the “ContractualS/D” field. Accordingly, the entity to the right of the text portion “SD” (namely, “02-15-2019”) may be used to populate the “ContractualS/D” field.

Additionally, or alternatively, the text portion “Actual SD” may match the synonym “actualSD” in the “ActualS/D” field. Accordingly, the entity to the right of the text portion “Actual SD” (namely, “Feb. 15, 2019”) may be used to populate the “ActualS/D” field.

Additionally, or alternatively, the text portion “Security Description:” may match the synonym “securitydescription” in the “Security” field. Accordingly, the entity to the right of the text portion “Security Description:” (namely, “Allergan PLC”) may be used to populate the “Security” field.

Additionally, or alternatively, the text portion “Quantity (shares):” may match the synonym “quantity” in the “Quantity” field. Accordingly, the entity to the right of the text portion “Quantity (shares):” (namely, 42) may be used to populate the “Quantity” field.

Additionally, or alternatively, the text portion “CUSIP:” may match the synonym “cusip” in the “SecurityID” field. Accordingly, the entity to the right of the text portion “CUSIP:” (namely, “G0177J108”) may be used to populate the “SecurityID” field.

Additionally, or alternatively, the text portion “Gross Rate:” may have no match.

Additionally, or alternatively, the text portion “Ex Date:” may match the synonym “exdate” in the “TradeDate” field. However, the “TradeDate” field may have already been populated. In this example, the entity to the right of the text portion “Ex Date:” (namely, “Feb. 14, 2019”) may be the same as the current content of the “TradeDate” field (populated based on the text portion “TD”). Therefore, the workflow management system 100 may simply skip over the text portion “Ex Date:”. If, on the other hand, a different entity is found, the workflow management system 100 may determine whether to replace the current content. For example, the current content may be replaced if the new match (e.g., “Ex Date:” and “exdate”) has a higher confidence score (e.g., Levenshtein distance) than the previous match (e.g., “TD” and “TD”).

Additionally, or alternatively, the text portion “WH Rate:” may have no match.

Additionally, or alternatively, the text portion “Pay Date:” may match the synonym “paydate” in the “ActualS/D” field. However, the “ActualS/D” field may have already been populated. The workflow management system 100 may simply skip over the text portion “Pay Date:”, or use confidence scores (e.g., Levenshtein distances) to determine whether to replace the current content, as described above in connection with the text portion “Ex Date:”.

Additionally, or alternatively, the text portion “Amount Due:” may match the synonym “amountdue” in the “ClaimAmount” field. Accordingly, the entity to the right of the text portion “Amount Due:” (namely, 642.0) may be used to populate the “ClaimAmount” field.

In this example, no text portion matches any synonym in the “PayInfo” field. Accordingly, the output data 1100 may not include the “PayInfo” field.

Although details of implementation are described above in connection with FIGS. 7, 8A-C, and 9-11, it should be appreciated that such details are provided solely for purposes of illustration. For instance, aspects of the present disclosure are not limited to any statically determined data schema, or any data schema at all. In some embodiments, a data schema may be created and/or modified dynamically, based on newly encountered data (e.g., the illustrative textual data 800 in the example of FIGS. 8A-C). For example, a new data field may be added for the text portion “Gross Rate,” and likewise for the text portion “WH Rate.”

Illustrative configurations of various aspects of the present disclosure are provided below.

A computer-implemented method for managing a workflow is provided. The method comprises acts of: identifying at least one entity in textual data; identifying at least one text portion adjacent to the at least one entity in the textual data; determining whether the at least one text portion matches a field in a data schema for a structured data object; in response to determining that the at least one text portion matches the field, determining whether a type of the at least one entity matches a type of the field; and in response to determining that the type of the at least one entity matches the type of the field, populating the field in the structured data object based on the at least one entity.

The method of configuration 1, wherein: the field comprises one or more synonyms; and determining whether the at least one text portion matches the field comprises comparing the at least one text portion against at least one synonym of the one or more synonyms in the field.

The method of configuration 2, wherein: comparing the at least one text portion against the at least one synonym in the field comprises computing a confidence score indicative of an extent to which the at least one text portion matches the at least one synonym in the field.

The method of configuration 1, further comprising an act of: storing the structured data object in a payload field of a data record in a database.

The method of configuration 4, wherein: the workflow is between a first organization and a second organization; the data record corresponds to a ticket associated with the workflow; and the textual data comprises ticket information received by the first organization from the second organization.

The method of configuration 4, wherein: the at least one entity is located to the right of the at least one text portion in the textual data.

The method of configuration 1, further comprising an act of: removing, from the at least one text portion, one or more spaces and/or punctuation marks.

A computer-implemented method for managing a workflow between a first organization and a second organization, the method comprising acts of: maintaining first and second data records associated with a ticket for the workflow, wherein: the first data record is associated with the first organization; and the second data record is associated with the second organization; and in response to an action taken by the first organization, updating both the first data record and the second data record to reflect the action.

The method of configuration 8, wherein: the first data record and the second data record are updated via a single database transaction.

The method of configuration 8, wherein: the first data record comprises a first payload field; the second data record comprises a second payload field; and updating both the first data record and the second data record comprises: updating the first data record based on the action taken by the first organization; and copying content of the first payload field into the second payload field.

The method of configuration 10, wherein: the content of the first payload field comprises a structured data object.

The method of configuration 11, wherein: the structured data object in the first payload field stores ticket information shared between the first and second organizations; and the first data record further comprises at least one other field storing ticket information specific to the first organization.

The method of configuration 8, wherein: prior to the action taken by the first organization: the first data record is in a first state; and the second data record is in a second state matching the first state; and updating both the first data record and the second data record comprises: updating the first data record to be in a third state; and updating the second data record to be in a fourth state matching the third state.

A system comprising: at least one processor; and at least one computer-readable storage medium having stored thereon instructions which, when executed, program the at least one processor to perform the method according to any of configurations 1-13.

At least one computer-readable storage medium having stored thereon instructions which, when executed, program at least one processor to perform the method according to any of configurations 1-13.

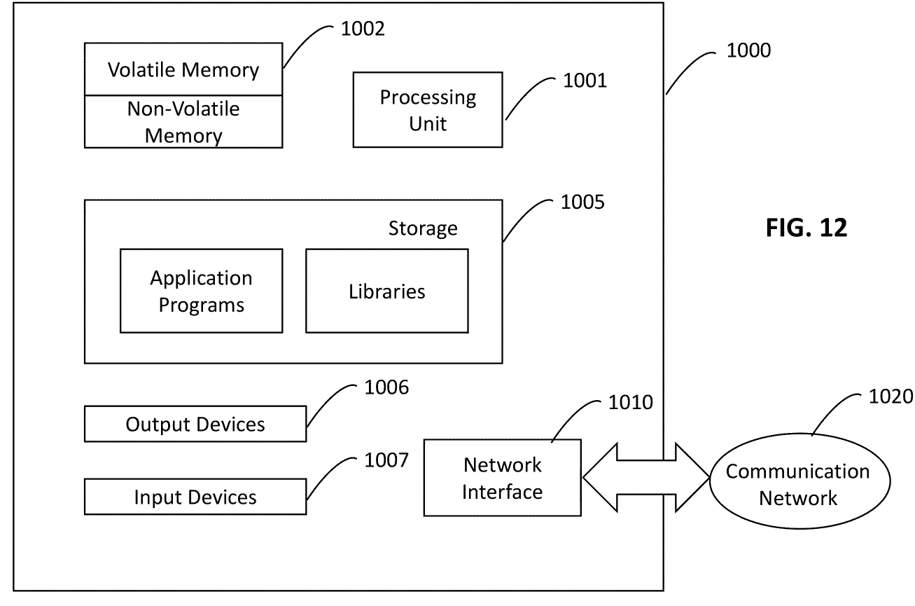

FIG. 12 shows, schematically, an illustrative computer 1000 on which any aspect of the present disclosure may be implemented.

In the example of FIG. 12, the computer 1000 includes a processing unit 1001 having one or more computer hardware processors and one or more articles of manufacture that comprise at least one non-transitory computer-readable medium (e.g., a memory 1002) that may include, for example, volatile and/or non-volatile memory. The memory 1002 may store one or more instructions to program the processing unit 1001 to perform any of the functions described herein. The computer 1000 may also include other types of non-transitory computer-readable media, such as storage 1005 (e.g., one or more disk drives) in addition to the memory 1002. The storage 1005 may also store one or more application programs and/or resources used by application programs (e.g., software libraries), which may be loaded into the memory 1002. To perform any of the illustrative functionalities described herein, processing unit 1001 may execute one or more processor-executable instructions stored in the one or more non-transitory computer-readable media (e.g., the memory 1002, the storage 1005, etc.), which may serve as non-transitory computer-readable media storing processor-executable instructions for execution by the processing unit 1001.

The computer 1000 may have one or more input devices and/or output devices, such as devices 1006 and 1007 illustrated in FIG. 12. These devices may be used, for instance, to present a user interface. Examples of output devices that may be used to provide a user interface include printers, display screens, and other devices for visual output, speakers and other devices for audible output, braille displays and other devices for haptic output, etc. Examples of input devices that may be used for a user interface include keyboards, pointing devices (e.g., mice, touch pads, and digitizing tablets), microphones, etc. For instance, the input devices 1007 may include a microphone for capturing audio signals, and the output devices 1006 may include a display screen for visually rendering, and/or a speaker for audibly rendering, recognized text.

In the example of FIG. 12, the computer 1000 also includes one or more network interfaces (e.g., a network interface 1010) to enable communication via various networks (e.g., a network 1020). Examples of networks include local area networks (e.g., an enterprise network), wide area networks (e.g., the Internet), etc. Such networks may be based on any suitable technology operating according to any suitable protocol, and may include wireless networks and/or wired networks (e.g., fiber optic networks).

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing descriptions and drawings are by way of example only.

The above-described embodiments of the present disclosure can be implemented in any of numerous ways. For example, the embodiments may be implemented using hardware, software, or a combination thereof. When implemented in software, the software code may be executed on any suitable processor or collection of processors, whether provided in a single computer or distributed among multiple computers.

Also, the various methods or processes outlined herein may be coded as software that is executable on one or more processors running any one of a variety of operating systems or platforms. Such software may be written using any of a number of suitable programming languages and/or programming tools, including scripting languages and/or scripting tools. In some instances, such software may be compiled as executable machine language code or intermediate code that is executed on a framework or virtual machine. Additionally, or alternatively, such software may be interpreted.

The techniques disclosed herein may be embodied as a non-transitory computer-readable medium (or multiple non-transitory computer-readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer storage media) encoded with one or more programs that, when executed on one or more processors, perform methods that implement the various embodiments of the present disclosure described above. The computer-readable medium or media may be portable, such that the program or programs stored thereon may be loaded onto one or more different computers or other processors to implement various aspects of the present disclosure as described above.

The terms “program” or “software” are used herein to refer to any type of computer code or set of computer-executable instructions that may be employed to program one or more processors to implement various aspects of the present disclosure as described above. Moreover, it should be appreciated that according to one aspect of this embodiment, one or more computer programs that, when executed, perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Program modules may include routines, programs, objects, components, data structures, etc. that perform particular tasks or implement particular abstract data types. Functionalities of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields to locations in a computer-readable medium that convey how the fields are related. However, any suitable mechanism may be used to relate information in fields of a data structure, including through the use of pointers, tags, or other mechanisms that establish how the data elements are related.

Various features and aspects of the present disclosure may be used alone, in any combination of two or more, or in a variety of arrangements not specifically described in the foregoing, and are therefore not limited to the details and arrangement of components set forth in the foregoing description or illustrated in the drawings. For example, aspects described in one embodiment may be combined in any manner with aspects described in other embodiments.

Also, the techniques disclosed herein may be embodied as methods, of which examples have been provided. The acts performed as part of a method may be ordered in any suitable way. Accordingly, embodiments may be constructed in which acts are performed in an order different from illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” “based on,” “according to,” “encoding,” and variations thereof herein, is meant to encompass the items listed thereafter and equivalents thereof as well as additional items.

What is claimed is:

1. A computer-implemented method for managing a workflow between a first organization and one or more second organizations, the method comprising acts of:
storing a first data record and one or more second data records associated with a ticket for the workflow, wherein:
the first data record is associated with the first organization; and
the one or more second data records are associated with the one or more second organizations, respectively; and
in response to an action taken by the first organization, updating both the first data record and the one or more second data records to reflect the action.

2. The method of claim 1, wherein:
the first data record is stored in a first workflow data instance associated with the first organization;
the one or more second data records are stored in one or more second workflow data instances associated with the one or more second organizations, respectively; and
the first workflow data instance is segregated from the one or more second workflow data instances.

3. The method of claim 2, wherein:
the first data record and the one or more second data records are updated atomically.

4. The method of claim 2, wherein:
the first workflow data instance is associated with a first tenant in a multi-tenant database;
the one or more second workflow data instances are associated with one or more second tenants in the multi-tenant database, respectively; and
the first data record and the one or more second data records are updated via a single database transaction.

5. The method of claim 1, wherein:
the first data record comprises a first payload field;
the one or more second data records comprise a second payload field; and
updating both the first data record and the one or more second data records comprises:
updating the first data record based on the action taken by the first organization; and
copying content of the first payload field into the second payload field.

6. The method of claim 5, wherein:
the content of the first payload field comprises a structured data object.

7. The method of claim 6, wherein:
the structured data object in the first payload field stores ticket information shared between the first organization and the one or more second organizations; and
the first data record further comprises at least one other field storing ticket information specific to the first organization.

8. The method of claim 6, wherein:
the structured data object in the first payload field stores ticket information common across a plurality of workflow types;
the workflow is associated with a first workflow type of the plurality of workflow types; and
the first data record further comprises at least one other field storing ticket information specific to the first workflow type.

9. The method of claim 1, wherein:
the first data record comprises a first payload field;
the one or more second data records comprise a second payload field; and
updating both the first data record and the one or more second data records comprises:
applying one or more data transformation rules to at least a portion of content of the first payload field, thereby obtaining a data transformation result; and
updating the second payload field based on the data transformation result.

10. The method of claim 1, wherein:
prior to the action taken by the first organization:
the first data record is in a first state; and
the one or more second data records are in one or more second states, respectively; the one or more second states match the first state;
updating both the first data record and the second data record comprises:
updating the first data record to be in a third state; and
updating the one or more second data records to be in one or more fourth states, respectively; and
the one or more fourth states match the third state.

11. The method of claim 1, wherein:
prior to the action taken by the first organization:
the first data record is in a first state; and
the one or more second data records are in one or more second states, respectively; the one or more second states match the first state;
updating both the first data record and the second data record comprises:
updating the first data record to be in a third state; and after the action taken by the first organization:
the one or more second data records remain in the one or more second states, respectively; and
the one or more second states match the third state.

12. A system comprising:
at least one processor; and
at least one computer-readable storage medium having stored thereon instructions which, when executed, program the at least one processor to perform a method for managing a workflow between a first organization and one or more second organizations, the method comprising acts of:
storing a first data record and one or more second data records associated with a ticket for the workflow, wherein:
the first data record is associated with the first organization; and
the one or more second data records are associated with the one or more second organizations, respectively; and
in response to an action taken by the first organization, updating both the first data record and the one or more second data records to reflect the action.

13. The system of claim 12, wherein:
the first data record is stored in a first workflow data instance associated with the first organization;
the one or more second data records are stored in one or more second workflow data instances associated with the one or more second organizations, respectively;
the first workflow data instance is segregated from the one or more second workflow data instances;
the first workflow data instance is associated with a first tenant in a multi-tenant database;
the one or more second workflow data instances are associated with one or more second tenants in the multi-tenant database, respectively; and
the first data record and the one or more second data records are updated via a single database transaction.

14. The system of claim 12, wherein:
the first data record comprises a first payload field;
the one or more second data records comprise a second payload field; and
updating both the first data record and the one or more second data records comprises:
updating the first data record based on the action taken by the first organization; and
copying content of the first payload field into the second payload field.

15. The system of claim 14, wherein:
the content of the first payload field comprises a structured data object;
the structured data object in the first payload field stores ticket information shared between the first organization and the one or more second organizations; and
the first data record further comprises at least one other field storing ticket information specific to the first organization.

16. The system of claim 14, wherein:
the content of the first payload field comprises a structured data object;
the structured data object in the first payload field stores ticket information common across a plurality of workflow types;
the workflow is associated with a first workflow type of the plurality of workflow types; and
the first data record further comprises at least one other field storing ticket information specific to the first workflow type.

17. The system of claim 12, wherein:
the first data record comprises a first payload field;
the one or more second data records comprise a second payload field; and
updating both the first data record and the one or more second data records comprises:
applying one or more data transformation rules to at least a portion of content of the first payload field, thereby obtaining a data transformation result; and
updating the second payload field based on the data transformation result.

18. The system of claim 12, wherein:
prior to the action taken by the first organization:
the first data record is in a first state; and
the one or more second data records are in one or more second states, respectively;
the one or more second states match the first state;
updating both the first data record and the second data record comprises:
updating the first data record to be in a third state; and
updating the one or more second data records to be in one or more fourth states, respectively; and
the one or more fourth states match the third state.

19. The system of claim 12, wherein:
prior to the action taken by the first organization:
the first data record is in a first state; and
the one or more second data records are in one or more second states, respectively; the one or more second states match the first state;
updating both the first data record and the second data record comprises:
updating the first data record to be in a third state; and after the action taken by the first organization:
the one or more second data records remain in the one or more second states, respectively; and
the one or more second states match the third state.

20. At least one computer-readable storage medium having stored thereon instructions which, when executed, program at least one processor to perform a method for managing a workflow between a first organization and one or more second organizations, the method comprising acts of:
storing a first data record and one or more second data records associated with a ticket for the workflow, wherein:
the first data record is associated with the first organization; and
the one or more second data records are associated with the one or more second organizations, respectively; and
in response to an action taken by the first organization, updating both the first data record and the one or more second data records to reflect the action.
